(19) United States
(12) Patent Application Publication
(10) Pub. No.: US 2010/0053969 A1
(43) Pub. Date: Mar. 4, 2010

(54) Laser light decoration

(76) Inventor: Kenneth Weinheimer, Onida, SD (US)

Correspondence Address: Gene R. Woodle, 3516 Woodle Drive, Rapid City, SD, 57702, US

(21) Appl. No.: 12/231,471

(22) Filed: Sep. 3, 2008

(51) Int. Cl. G02B 27/20

(52) U.S. Cl. 362/259

(57) ABSTRACT

A laser light decoration is disclosed in which a decorative string of light, for example, is replaced by a line of laser light reflected from a plurality of adjustable mirrors. A laser is provided which produces a fan or plane of laser light. The laser light is intercepted by a plurality of mirrors which may be tilted or rotated such that a reflected line of light is projected upon a surface and aligned appropriately by adjusting the mirrors.

### BACKGROUND OF THE INVENTION

1. Field of the Invention

The present invention relates generally to decorative lighting and more specifically to using laser light and mirrors for decorative lighting.

2. Background Information

For many years people have enjoyed using lights to decorate their homes and other areas. Perhaps most common are lighting effects people use to decorate their homes for Christmas. In the United States a great many homes are decorated with lights to celebrate the Christmas season.

The most common form of light for such decoration is a string a small light bulbs connected by electrical wiring. Often such strings of lights are placed along the eves of a home and, when plugged in to an electric circuit, provide a decorative line of lights along the eves. There is a wide variety of such light strings including solid colors, multicolored strings, blinking lights, and what are often known as icicle lights.

Putting up and taking down these light strings is an annual chore for millions of people. The light strings are most often used for several years and the strings must be inspected for burned out bulbs and such bulbs replaced. Such strings of lights are also notorious for becoming tangled and requiring time and effort for untangling them. Several patents have been issued for inventions which address this problem including those to McAllister et al. (U.S. Pat. No. 5,064,067; Nov. 12, 1991) and Wing (U.S. Pat. No. 4,917,323; Apr. 17, 1990). The hanging of such lights also often involves the use of specially constructed light hangers and balancing on a ladder to reach the eves or other areas where the lights are to be placed. Furthermore, the power necessary to light millions of Christmas lights extensive.

The instant invention, a laser light decoration, is believed to solve, in a unique and effective manner, a variety of problems relating to the use of lights for decoration of homes and businesses. Such problems include: replacing bulbs, untangling light strings, purchasing and placing light hangers, the somewhat dangerous use of a ladder to place lights, and the large amount of electricity necessary to power such lights.

The ideal laser light decoration should be capable of providing decoration without the necessity for a string of individual bulbs. The ideal laser light decoration should also provide a method of light decoration which has no wiring which may become tangled. The ideal laser light decoration should also provide a method of decorating a home or business without the need for light string hangers. The ideal laser light decoration should also be capable of decorating a home or business without the need for use a ladder. The ideal laser light decoration should also be capable of providing home or business light decoration which uses much less electricity than conventional string lighting. The ideal laser light decoration should also be simple, inexpensive, rugged, and easy to use.

### SUMMARY OF THE INVENTION

The laser light decoration of the instant invention uses a single laser light which is reflected off of a plurality of mirrors to provide decorative lighting effects which are very similar to those provided by a string of conventional lights. The laser, which is widely available, provides a fan or plane of light rather than a single beam. The laser, which projects generally upward, is affixed to a stand which may be may be placed in the yard of a home which is to be decorated. A plurality of mirrors are affixed to the stand above the laser such that the mirrors intercept the fan of light from the laser and project the light from the laser toward the house. In this example, three mirrors will be used; but, as may be easily seen, a number of different combinations of mirrors could be used.

One of the mirrors, the central mirror, is placed directly above the laser. A left mirror is placed to one side of the central mirror and a right mirror is placed on the other side of the central mirror. The mirrors are affixed to the stand using universal type joints such that they may be both rotated an infinite number of degrees and tilted at an infinite number of angles. The central mirror, for example, may be tilted and rotated such that it reflects a line of horizontal light from one end of the eves to the other. The left mirror may be adjusted such that it reflects a line of light which follows the angle of the right eve of the house and the right mirror adjusted such that it reflects a line of light with follows the angle of the left eve. Thus, the three lines of reflected light form an isosceles triangle of light which generally follows the roof line of the house.

As will be understood, more than one laser light decoration could be used. For example, two of the instant invention could be used to light two sides of a house. It will also be understood that the instant invention could be used for a wide variety of decorative or other purposes on a wide variety of structures or surfaces.

In a second embodiment, the mirrors are configured such that a series of relatively thin lines of mirror material are exposed. That is portions of the mirrors are masked such that only a series of parallel lines of reflective material are exposed. In this embodiment, rather than projecting a solid line of light upon a surface, a line of individual dots of light will be projected. In this embodiment, the instant invention acts to simulate more accurately a string of individual lights.

One of the major objects of the laser light decoration of the instant invention is provide decoration without the necessity for a string of individual bulbs.

Another objective of the present invention is to provide a method of light decoration which has no wiring which may become tangled.

Another objective of the present invention is to provide a method of decorating a home or business without the need for light string hangers.

Another objective of the present invention is to provide a device which is capable of decorating a home or business without the need for use a ladder.

Another objective of the present invention is to provide an apparatus for providing home or business light decoration which uses much less electricity than conventional string lighting.

Another objective of the present invention is to provide a milling process which is simple, inexpensive, rugged, and easy to use.

These and other features of the invention will become apparent when taken in consideration with the following detailed description and the drawings.

### BRIEF DESCRIPTION OF THE DRAWINGS

FIG. 1 is a front view of the laser light decoration of the instant invention;

FIG. 2 is a side view of the laser light decoration of the instant invention;

FIG. 3 is a rear view of the instant invention in use to decorate a home; and

FIG. 4 is a front view of a mirror of the instant invention in a second embodiment.

### DESCRIPTION OF A PREFERRED EMBODIMENT

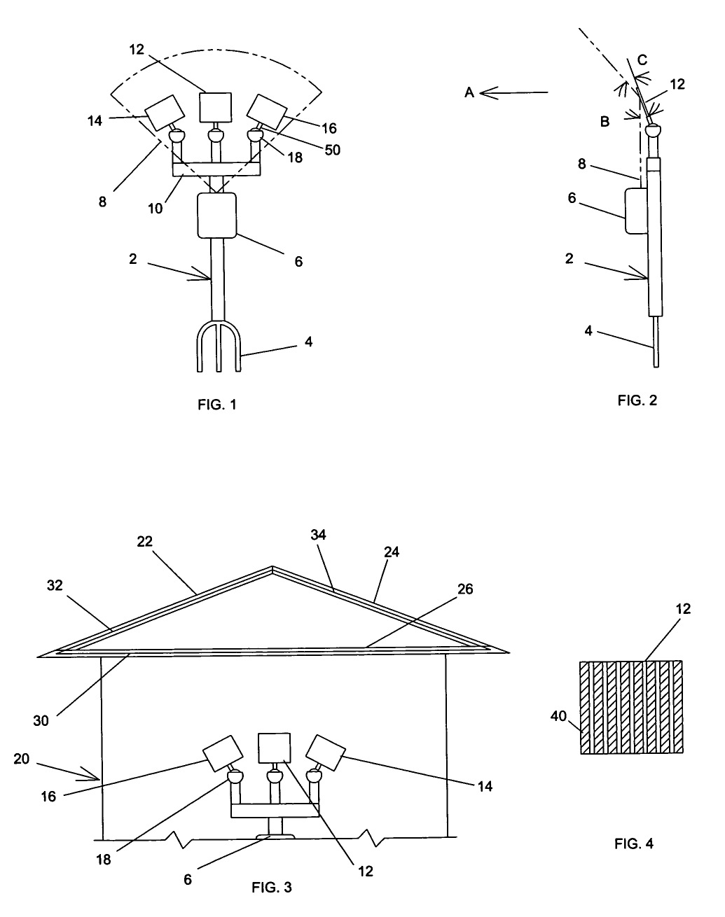

Referring to the drawings, FIGS. 1, through 5, there is shown a preferred form of the laser light decoration of the instant invention and a second embodiment. The instant invention is described and illustrated as using three mirrors, but more or fewer mirrors could be used without changing the spirit of the invention.

Now referring to FIG. 1, a front view of the laser light decoration of the instant invention is shown. A stand 2 is provided which has a fork 4 at its bottom end. The fork 4 may be forced into, for instance, the lawn of a house, such that the stand 2 is close to vertical. Of course, said fork 4 could easily be replaced by a plate in a plane perpendicular to the vertical portion of said stand 2 such that it could be placed without the need to push said fork 4 into a lawn. A laser 6 is affixed to said stand 2 such that it projects generally upward. The laser 6 is of a type which produces a fan or plane of light rather than a single beam. Such lasers are widely available and may be obtained from companies such as Sears, Roebuck and Co., Hoffman Estates, Ill. 60179 (4-in1 Level with Laser Track™). The fan of light from said laser 6 is illustrated in phantom lines as fan 8. A bracket 10 is affixed to the top of said stand 2 such that it is perpendicular to said stand 2.

Still referring to FIG. 1, three mirrors are affixed to the bracket 10. A central mirror 12 is affixed directly above said laser 6. A left mirror 14 is affixed to the left of the central mirror 12 and a right mirror 16 if affixed to the right of said central mirror 12. All three mirrors are affixed to said bracket 10 by means of three joints 18. The joints 18 are of a universal type such that the three mirrors may be both rotated in an infinite number of degrees and tilted to an infinite number of angles. In the preferred embodiment said joints 18 are of a ball and socket type, but other types could be used. Said joints 18 are sufficiently loose that the central mirror 12, the left mirror 14 and the right mirror 16 may be tilted and rotated by hand, but sufficiently stiff that said central mirror 12, said left mirror 14, and said right mirror 16 will stay in place after being positioned. All three mirrors are configured such that they may be tilted and rotated such that they may intercept the fan 8 of laser light and reflect the laser light to project a line of light upon a surface. A strut 50 is affixed to each of the three mirrors and is also affixed to the ball portion of said joint 18.

Now referring to FIG. 2, a side view of the laser light decoration of the instant invention is shown. An arrow A shows the direction of the house or other surface to be decorated or otherwise lit. This view better shows the capability of one of the three mirrors (in this case said central mirror 12) of intercepting and reflecting said fan 8 of laser light. Said laser 6 projects said fan 8 of light upward. Said central mirror 12 may be tilted top forward in the direction of said arrow A such that it intercepts said fan 8 of laser light. According to well known principles of optics, the angle designated angle B is equal to the angle designated as angle C. Although it is better seen in FIG. 3 described below, the reflected laser light as shown where angle C is shown projects a line of light in the direction of arrow A.

Referring now to FIG. 3, a rear view of the instant invention in use to decorate a house is shown. An end view of a representative house 20 is shown. The house 20 includes a right eve 22 and a left eve 24 along the roof line and a central eve 26 which, in this example, connects the bottoms of the right eve 22 and the left eve 24. As is shown in FIG. 2 and described above, said mirror 12 is tilted with its top toward said house 20 and reflects a line of laser light from said laser 6 such that the line of laser light is projected upon the central eve 26 to show a horizontal central line 30. Said right mirror 16 is also tilted with its top toward said house 20 and is further tilted with its top away from said central mirror 12 such that it reflects a line of laser light from said laser 6 such that the line of laser light is projected upon the right eve 22 to show a right line 32 on said right eve 22. Said left mirror 14 is also tilted with its top toward said house 20 and is further tilted with its top away from said central mirror 12 such that it reflects a line of laser light from said laser 6 such that the line of laser light is projected upon the left eve 24 to show a left line 34 on said left eve 24. Because said bracket 10 may not be exactly parallel to the surface of said house 20, it may also be necessary to rotate any of the three mirrors within any of said joints 18 such that the projected lines of laser light line up precisely with the three eves. The lines of light projected upon said house 20 are easily seen and said central mirror 12 may be tilted or rotated as necessary such that central line 30 is aligned with said central eve 26 appropriately. Similarly, said left mirror 14 may be titled or rotated as necessary such that left line 34 is aligned with said left eve 24 appropriately and said right mirror 16 may be tilted or rotated as necessary such that right line 32 is aligned with said right eve 22 appropriately. As may be easily seen, various numbers of mirrors is various configurations could be used to produce a number of different effects all within the spirit of the instant invention and surfaces other than a house could be decorated.

Referring now to FIG. 4, a front view of a mirror of the instant invention in a second embodiment is shown. This figure shows the reflective side of said central mirror 12. However, much of the surface of said central mirror 12 is masked by placing a plurality of strips of tape 40 on the surface of said central mirror 12. The strips of tape 40 are placed parallel with each other such that lines of the reflective material of said central mirror 12 remain exposed. In this embodiment, said central mirror 12 would project a series of dots or short dashes upon said central eve 26 of FIG. 3 rather than a solid line such as said line 30. Of course, either said left mirrors 14 or said right mirror 16 could be similarly masked to create a similar effect. Black electrical tape is used for the tape 40 in this embodiment, but paint or any similar material which masks portions of said mirror 12 could be used.

As will be seen, the instant invention eliminates the need for individual bulbs and wiring connecting the bulbs. No light string hangers are required. No ladder is required because the operator never has to leave the ground. Furthermore, the laser light decoration of the instant invention requires much less energy than a conventional string of lights, because said laser 6 operates on only a couple of “AA” or similar batteries.

In the preferred embodiment, all elements are conventional and may be secured from a variety of sources. In the preferred embodiment, all of the elements of said stand 2 are made from aluminum, but materials having similar characteristics of strength and weather resistance may be used.

While preferred embodiments of this invention have been shown and described above, it will be apparent to those skilled in the art that various modifications may be made in these embodiments without departing from the spirit of the present invention.

I claim:

1. A laser light decoration for providing light decoration on a surface such as a house comprising:
(1) a stand which is capable of being positioned upright at a distance from the surface to be decorated;
(2) a laser light source which is capable of projecting a plane of laser light and which is affixed to the stand; and
(3) at least one mirror which is also affixed to said stand and which is adjustable and capable of intercepting the plane of laser light emitted from the laser such that a line of light is projected upon the surface to be decorated and the mirror being capable of being adjusted such that the line of light appears on the desired location.

2. The laser light decoration of claim 1 in which the reflective surface of said mirror is masked such that a series of dots is projected upon the surface to be decorated rather than a line.

3. A laser light decoration for providing light decoration on a surface such as a house comprising:
(1) a stand which is capable of being positioned upright at a distance from the surface to be decorated;
(2) a bracket affixed to the stand;
(3) a plurality of universal joints affixed to the bracket;
(4) a plurality of mirrors each of which is affixed to one of the universal joints such that the mirrors may be both rotated and tilted using said universal joints; and
(5) a laser light source which is capable of projecting a plane of laser light, the laser light source being affixed to said stand such that the plane of laser light projected from said laser light source may be intercepted by said mirrors and reflected toward the surface to be decorated;
whereby, the plane of laser light from said laser light source may be intercepted by said mirrors and a line of light reflected upon the surface to be decorated and said mirrors may be tilted or rotated such that the lines of reflected light create a desired decorative pattern upon the surface to be decorated.

4. The laser light decoration of claim 2 in which one or more of the reflective surfaces of said mirrors are masked such that a series of dots is projected upon the surface to be decorated rather than a line.
